(19) United States
(12) Patent Application Publication
(10) Pub. No.: US 2004/0075618 A1
(43) Pub. Date: Apr. 22, 2004

(54) Advertisement and display mechanism for providing high resolution advertisement messages and method therefor

(76) Inventors: Raymond Kohan, Scottsdale, AZ (US); Delilah Kohan, Santa Ana, CA (US); James M. Hudson, Santa Ana, CA (US)

Correspondence Address: WEISS & MOY PC, 4204 NORTH BROWN AVENUE, SCOTTSDALE, AZ, 85251, US

(21) Appl. No.: 10/274,643

(22) Filed: Oct. 18, 2002

(51) Int. Cl. G09G 5/00

(52) U.S. Cl. 345/1.1

(57) ABSTRACT

A high resolution advertisement system has one or more high resolution video displays for displaying text, graphics, and moving graphic advertisements. A protective cover is coupled to each of the one or more high resolution video displays for protecting each of the one or more high resolution video displays. A video player is coupled to each of the one or more high resolution video displays for transmitting advertisement data to be displayed on each of the one or more high resolution video displays.

### BACKGROUND OF THE INVENTION

1. Field of the Invention

This invention relates generally to advertisement devices and, more specifically, to an advertisement device which may be installed in airports and other locations to provide high resolution advertisement messages.

2. Description of the Prior Art

The key to selling a product or service is how that particular product or service is marketed. Presently, there are many different ways in which a product or service may be marketed. One of the most widely used methods of advertising is the use of billboards or signs (hereinafter billboards). Most billboards are place in areas where there is a high volume of traffic. Areas such as freeways, airport terminals, etc. are common places where billboards are located. The problem with billboards and signs are that they don't tend to grab most peoples' attention. Most billboards and signs contain either a printed message, a picture, and/or both. The messages and pictures generally cannot be changed other than replacing the entire billboard or sign. Furthermore, the pictures are still pictures and of poor quality.

The above problems also occur on other types of advertisement signs which are placed on buses, taxis, bus stop benches, and the like. All of these types of advertisement signs cannot be changed other than by replacing the entire sign. Furthermore, as stated above, the pictures on the advertisement signs are still pictures of poor quality.

Therefore, a need existed to provide an improved advertisement system. The improved advertisement system would be able to display multiple ads without the need to totally remove or alter the advertisement system. The improved advertisement system would further allow graphic images of a higher quality than that currently displayed by present systems. The improved advertisement system would further allow movable images to be displayed. The improved advertisement system would display the ads in a high resolution fashion.

### SUMMARY OF THE INVENTION

In accordance with one embodiment of the present invention, it is an object of the present invention to provide an improved advertisement system.

It is another object of the present invention to provide an improved advertisement system that would be able to display multiple ads without the need to totally remove or alter the advertisement system.

It is still another object of the present invention to provide an improved advertisement system that would further allow graphic images of a higher quality than that currently displayed by present systems.

It is yet another object of the present invention to provide an improved advertisement system that would further allow movable images to be displayed.

It is still another object of the present invention to provide an improved advertisement system that would display the ads in a high resolution fashion.

### BRIEF DESCRIPTION OF THE EMBODIMENTS

In accordance with one embodiment of the present invention, a high resolution advertisement system is disclosed. The high resolution advertisement system has one or more high resolution video displays for displaying text, graphics, and moving graphic advertisements. A protective cover is coupled to each of the one or more high resolution video displays for protecting each of the one or more high resolution video displays. A video player is coupled to each of the one or more high resolution video displays for transmitting advertisement data to be displayed on each of the one or more high resolution video displays.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is an elevated perspective view of a video display panel used in the present invention.

FIG. 2 is one embodiment of the present invention in use on a luggage carousel.

FIG. 3 is a video display panel used in the luggage carousel depicted in FIG. 2.

FIG. 4 is another embodiment of the present invention in use on a luggage carousel.

FIGS. 5A-5C depicts different views of one embodiment of the present invention installed on a bench.

FIG. 6 is an elevated perspective view of one embodiment of the present invention installed on a road sign.

FIG. 7 is an elevated perspective view of one embodiment of the present invention installed on a billboard sign.

FIG. 8 is a front view of one embodiment of the present invention installed on a bus.

FIG. 9 is an elevated perspective view of one embodiment of the present invention installed on an escalator.

FIG. 10 is a side view of the escalator depicted in FIG. 9.

### DETAILED DESCRIPTION OF THE PREFERRED EMBODIMENT

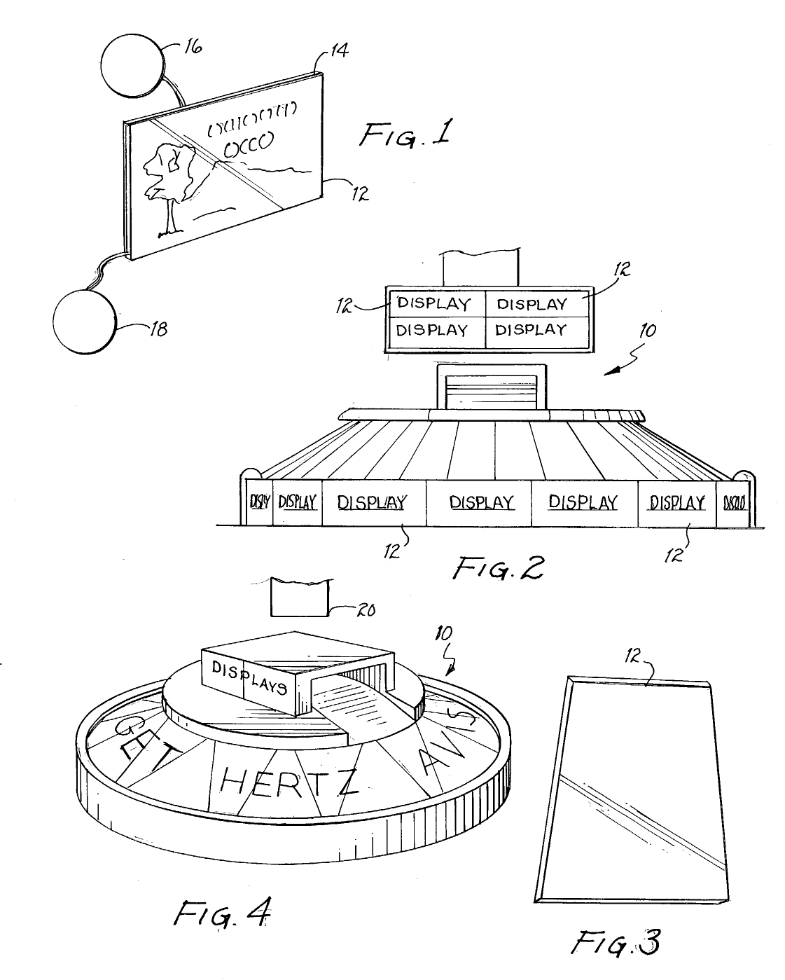

Referring to FIG. 2, one embodiment of the present invention is shown. FIG. 2 depicts a luggage carousel advertising system 10 (hereinafter luggage carousel 10). The luggage carousel 10 can be installed at airports, train stations, bus terminals, and the like. The luggage carousel 10 will allow different companies to advertise their products in high traffic areas. The luggage carousel 10 will allow companies to advertise on the side of the luggage carousel 10, above the luggage carousel 10, and on the rotating section of the luggage carousel 10.

The luggage carousel 10 is comprised of a plurality of video displays 12. The video displays 12 are able to display high resolution text, images, and moveable images. Each video display 12 can display multiple advertisements.

Referring to FIG. 1, one embodiment of the video displays 12 is shown. The video displays 12 is generally a thin profile video display 12. For example, the video display 12 may be a plasma screen, a Liquid Crystal Display (LCD) panel, a fiber channel screen, and the like. It should be noted that the above are given as an example and should not be seen as to limit the scope of the present invention.

The video displays 12 will generally have some type of protective cover 14. The protective cover 14 may encase the entire video display 12 or just the screen 16 of the video display 14. The protective cover 14 is used to protect the video display 12 from the environment and from individuals who may try and damage the video display 12.

The video displays 12 depicted in FIG. 1 are generally placed on a bottom section of the luggage carousel 10 and above the luggage carousel 10 as shown in FIG. 2. In addition, advertisements may be displayed on the rotating section of the luggage carousel 10 as shown in FIG. 4. The advertisements on the rotating section of the luggage carousel 10 may be displayed in several different manners.

First, video displays 12 may be used. The video displays 12 are the same video displays as discussed above. The main difference is that the video displays 12 would be more trapezoidal in shape as shown in FIG. 3. The trapezoidal shape of the video displays 12 will allow for the rotation and movement of the video displays 12 as the video displays 12 rotate around the luggage carousel 10.

Alternatively, advertisement information may be projected onto the rotating section of the luggage carousel 10. A projector 20 is located above the luggage carousel 10. The projector 20 will send down images to be displayed on the rotating section of the luggage carousel 10. Thus, the rotating section will act like a projector screen in displaying the advertisement images. If a projector 20 is used, the rotating section may need to be covered with a light color material in order to provide a clearer advertisement image. The rotating section may be painted, have a material coupled to the top surface, etc. in order to have a light color surface.

The video displays 12 are coupled to a video player 16. The video player 16 will display text, graphics, images, etc. on the video displays 12. The video player 16 may be any type of device which is able to store and transmit the advertisement information. The video player 16 may further have inputs which would allow one to download or program the video player either locally or from a remote location. For example, one may program the video player 16 by going directly to the location where the video player 16 is located and connecting a device to the input of the video player 16 to reprogram the video player 16. Alternatively, the input to the video player 16 may be coupled to a networked system which would allow the video player 16 to be programmed from a remote location. Video players 16 like video cassette players, dvd players, etc. may be used. Alternatively, the video player 16 may be a video processor coupled to a data storage device.

Each video display 12 may show the same advertisement or a different advertisement. Multiple advertisements may be shown on a single video display 12. The video displays 12 may be configures so that one large advertisement is displayed across continuous video displays 12. The above is determined on how each video display 12 is coupled to the video player 16 and how the video player 16 is programmed.

Each video display 12 is further coupled to a power supply 18. The power supply 18 is used to illuminate and power each video display 18. The power supply 18 can be any type of power source commonly used today. The video displays 18 may be wired to an electrical grid system, a battery, solar panel, and the like. It should be noted that the above are just given as examples and should not be seen as to limit the scope of the present invention.

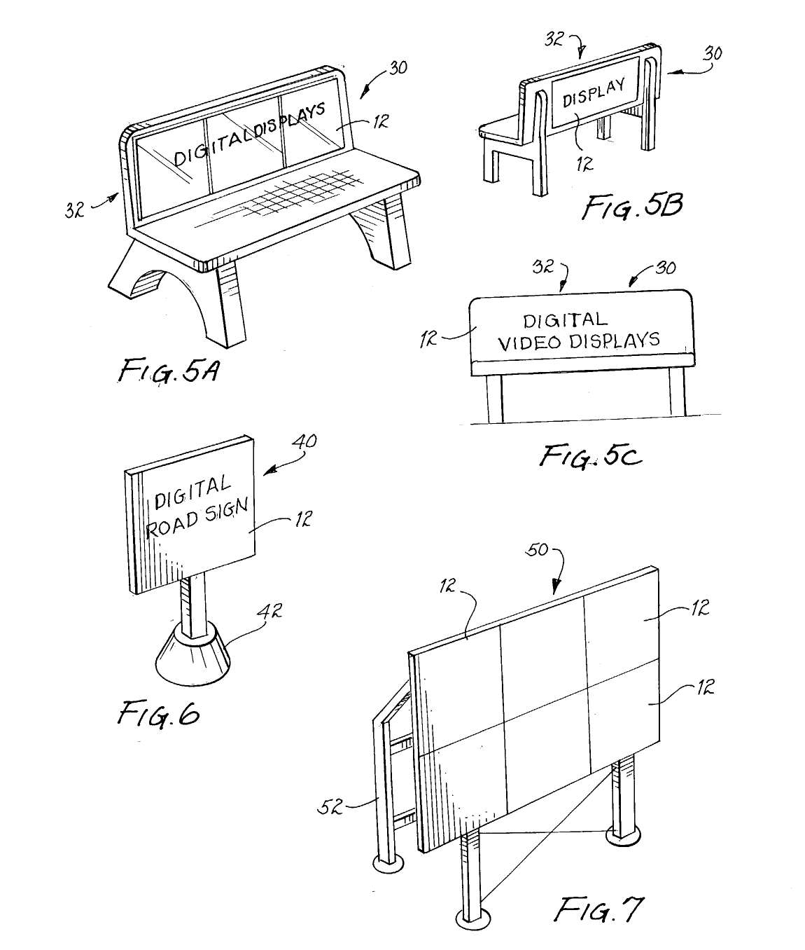

It should be noted that the video displays 12 disclosed above may be used to display advertisements in other areas. Referring now to FIGS. 5A-5C wherein like numerals and symbols represent like elements, an advertisement bench 30 is shown. The advertisement bench 30 may be used at bus stops, parks, or anywhere else a bench may be needed. The advertisement bench 30 will have one or more video displays 12 located on the back rest section 32 of the advertisement bench 30. The video displays 12 are the same as described above and will further have the protective cover 14 to protect the video display 12 from the environment and from individuals who may try and damage the video display 12. Since most benches are placed outdoors, the advertisement bench 30 may use a solar panel as the power supply 18. The legs 34 of the advertisement bench 30 may be hollowed out in order to store the video player 16.

Referring now to FIG. 6 wherein like numerals and symbols represent like elements, the video displays 12 may be used for an advertisement road sign 40 is shown. The advertisement road sign 40 may be used to replace current road/construction LED signs which only allow text messages. The advertisement road sign 40 is similar to prior art signs. The main difference is that the advertisement road sign 40 will use a video display 12. The video display is the same as described above. Again, since the advertisement road sign 40 is generally place outside, a solar panel may be used as the power supply 18. The video player 16 may be position in the stand 42 which holds the advertisement road sign 40 in an upright position.

Referring to FIG. 7 wherein like numerals and symbols represent like elements, the video display 12 may further be used as an advertisement billboard 50. The advertisement billboard 50 would be comprised of a plurality of video displays 12 coupled together. Each video display 12 may show the same advertisement or a different advertisement. However, in general, the video displays 12 would be configures so that one large advertisement is displayed across continuous video displays 12. Again, since the advertisement billboard 50 is generally place outside, a solar panel may be used as the power supply 18. The video player 16 may be position in the stand 52 which holds the advertisement billboard 50 in an upright position. Alternatively, a secure box may be coupled to the advertisement billboard 50 to securely hold the video player 16.

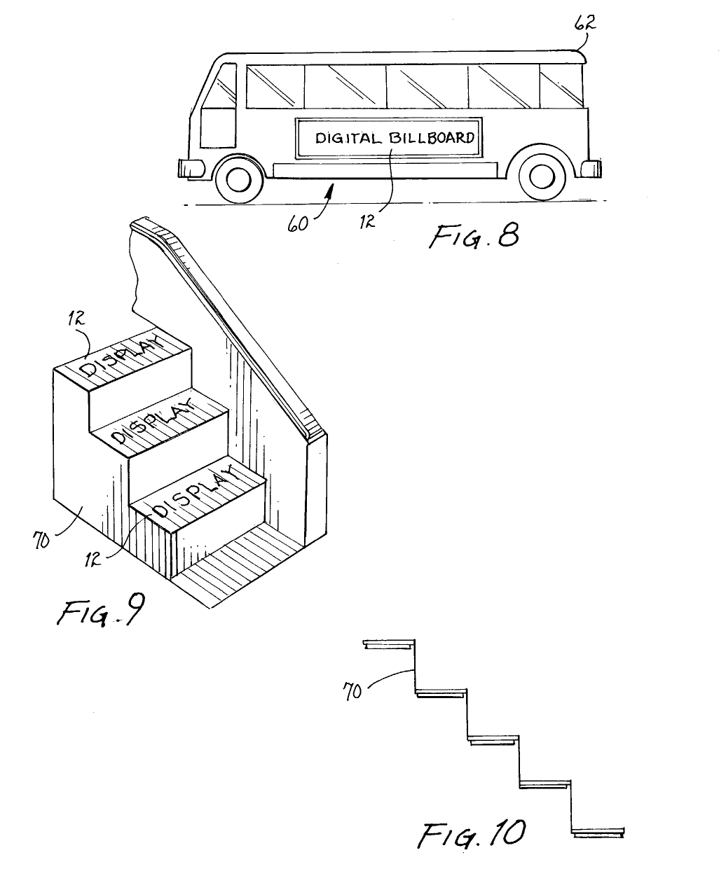

Referring now to FIG. 8 wherein like numerals and symbols represent like elements, the video display 12 may further be used as an advertisement vehicle sign 60 for transportation vehicles 62. The advertisement vehicle sign 60 could be placed on buses, trams, taxis, etc. In the embodiment depicted in FIG. 8, the advertisement vehicle sign 60 is coupled to a side of a bus. However, this should not be seen as to limit the scope of the present invention. The advertisement vehicle sign 60 is just the video display 12 previously discussed. The video display 12 coupled be coupled to the power supply 18 of the vehicle 62. Alternatively, a solar panel coupled be coupled to the roof of the vehicle and to the video display 12. The video player 16 can be located anywhere on the vehicle 62.

Referring now to FIGS. 9 and 10 wherein like numerals and symbols represent like elements, the video display 12 may be used on a moving walkway or escalator 70 (hereinafter escalator 70). Each step 72 would have a slight indentation which would hold a video display 12. Each video display 12 would be coupled to a video player 16 and a power supply as disclosed above.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A high resolution advertisement system comprising, in combination:
one or more high resolution video displays for displaying text, graphics, and moving graphic advertisements;
a protective cover coupled to each of the one or more high resolution video displays for protecting each of the one or more high resolution video displays; and
a video player coupled to each of the one or more high resolution video displays for transmitting advertisement data to be displayed on each of the one or more high resolution video displays.

2. A high resolution advertisement system in accordance with claim 1 wherein the video displays are plasma screen.

3. A high resolution advertisement system in accordance with claim 1 wherein the video displays are Liquid Crystal Display (LCD) panels.

4. A high resolution advertisement system in accordance with claim 1 wherein the video displays are fiber channel screens.

5. A high resolution advertisement system in accordance with claim 1 wherein the video displays are coupled to a luggage carousel.

6. A high resolution advertisement system in accordance with claim 5 wherein the video displays are positioned above the luggage carousel and coupled to a bottom section of the luggage carousel.

7. A high resolution advertisement system in accordance with claim 6 further comprising video displays coupled to a rotating section of the luggage carousel to show advertisement information on the rotating section.

8. A high resolution advertisement system in accordance with claim 6 further comprising a projector positioned above the luggage carousel for projecting advertisement information on a rotating section of the luggage carousel.

9. A high resolution advertisement system in accordance with claim 1 wherein the video displays are coupled to a back rest section of a bench.

10. A high resolution advertisement system in accordance with claim 9 further comprising:
a hollowed section in a leg of the bench for housing the video player; and
a solar panel coupled to the video displays for powering the video displays.

11. A high resolution advertisement system in accordance with claim 10 wherein the video displays are coupled to a front section and a back section of the back rest section of a bench.

12. A high resolution advertisement system in accordance with claim 1 wherein the video displays are used as a road advertisement sign.

13. A high resolution advertisement system in accordance with claim 1 wherein the video displays are used as a road advertisement billboard sign.

14. A high resolution advertisement system in accordance with claim 1 wherein the video displays are coupled to a vehicle.

15. A high resolution advertisement system in accordance with claim 1 wherein the video displays are positioned in steps on an escalator.
